(19) United States
(12) Patent Application Publication
(10) Pub. No.: US 2025/0062077 A1
(43) Pub. Date: Feb. 20, 2025

(54) METHOD FOR PRODUCING ELECTROLYTIC CAPACITOR

(71) Applicant: Panasonic Intellectual Property Management Co., Ltd., Osaka (JP)

(72) Inventors: Yasuhiro NISHIMURA, HYOGO KEN (JP); Honami SERIZAWA, OSAKA FU (JP); Miyoko MASUDA, KYOTO FU (JP); Tatsuji AOYAMA, KYOTO FU (JP)

(21) Appl. No.: 18/721,554

(22) PCT Filed: Dec. 23, 2022
(86) PCT No.: PCT/JP2022/047662

§ 371 Date: Jun. 18, 2024

(30) Foreign Application Priority Data
Dec. 24, 2021 (JP) 2021-211296

(51) Int. Cl. H01G 9/00; H01G 9/15

(52) U.S. Cl. CPC H01G 9/0032; H01G 9/151

(57) ABSTRACT

A disclosed manufacturing method includes a laminated body formation step of forming a laminated body by laminating an anode foil, a cathode foil, and a separator such that the separator is arranged between the anode foil and the cathode foil, and a polymer layer formation step of impregnating the laminated body with a dispersion liquid containing a conductive polymer and a dispersion medium, and then evaporating at least a portion of the dispersion medium of the dispersion liquid in the laminated body to form a conductive polymer layer containing the conductive polymer in the laminated body. The laminated body formation step further includes a step of surrounding an outer periphery of the laminated body with a binding member. The separator has a protrusion part that protrudes from the binding member. In the polymer layer formation step, the laminated body is impregnated with the dispersion liquid from the protrusion part.

### TECHNICAL FIELD

The present disclosure relates to a manufacturing method for an electrolytic capacitor.

### BACKGROUND ART

As electrolytic capacitors, electrolytic capacitors are known which include a wound body of an anode foil, a cathode foil, and a separator. One example of such an electrolytic capacitor includes a conductive polymer layer that is arranged in the wound body. The conductive polymer layer is formed by impregnating the wound body with a dispersion liquid containing conductive polymer particles, for example.

Patent Literature 1 (Japanese Laid-Open Patent Publication No. 2009-289833) discloses “a manufacturing method for a solid electrolytic capacitor, including: an arrangement step of arranging a separator between an anode foil that is made of aluminum and whose surface has undergone a chemical conversion treatment and a cathode foil that holds carbide particles on a surface thereof; and a formation step of allowing a conductive polymer dispersion solution having a pH of 5 to 8 to impregnate a space between the anode foil and the separator and a space between the cathode foil and the separator, and drying the solution to form a solid electrolyte layer”.

On the other hand, other than such wound-type electrolytic capacitors, electrolytic capacitors using a laminated body in which a polar plate and a separator are laminated in one direction have also been proposed. However, when such a laminated body is impregnated with a conductive polymer dispersion liquid, the conductive polymer dispersion liquid does not easily penetrate into the inside of the laminated body, and therefore the periphery and the center of the laminated body tend to have different degrees of impregnation. This makes it likely to be difficult to form a conductive polymer layer with uniformity.

### CITATION LIST

### Patent Literature

PTL 1: Japanese Laid-Open Patent Publication No. 2009-289833

### SUMMARY OF INVENTION

### Technical Problem

An object of the present disclosure is to provide a novel manufacturing method for an electrolytic capacitor with excellent characteristics that includes a laminated body having a conductive polymer layer.

### Solution to Problem

An aspect of the present disclosure relates to a manufacturing method for an electrolytic capacitor. The manufacturing method is a manufacturing method for an electrolytic capacitor that includes at least one anode foil that has a dielectric layer formed on a surface thereof, at least one cathode foil, and at least one separator, the manufacturing method including: a laminated body formation step of forming a laminated body by laminating the anode foil, the cathode foil, and the separator such that the separator is arranged between the anode foil and the cathode foil; and a polymer layer formation step of impregnating the laminated body with a dispersion liquid containing a conductive polymer and a dispersion medium, and then evaporating at least a portion of the dispersion medium of the dispersion liquid in the laminated body to form a conductive polymer layer containing the conductive polymer in the laminated body, in which the laminated body formation step further includes a step of surrounding an outer periphery of the laminated body with a binding member, the separator has a protrusion part that protrudes from the binding member, and in the polymer layer formation step, the laminated body is impregnated with the dispersion liquid from the protrusion part.

### Advantageous Effects of Invention

According to the present disclosure, it is possible to manufacture an electrolytic capacitor with excellent characteristics that includes a laminated body having a conductive polymer layer.

While novel features of the present invention are set forth in the appended claims, both the configuration and content of the present invention, as well as other objects and features of the present application, will be better understood from the following detailed description given with reference to the drawings.

### BRIEF DESCRIPTION OF DRAWINGS

FIG. 1A A top view schematically showing one step in a manufacturing method according to a first embodiment.

FIG. 1B A cross-sectional view taken along line IB-IB in FIG. 1.

FIG. 2A A top view schematically showing one step in the manufacturing method according to the first embodiment.

FIG. 2B A top view schematically showing one step following the step in FIG. 2A.

FIG. 2C A top view schematically showing one step following the step in FIG. 2B.

FIG. 3 A cross-sectional view schematically showing one step according to the first embodiment.

FIG. 4 A top view showing an example of an electrolytic capacitor manufactured according to the first embodiment.

FIG. 5 A top view schematically showing one step in a manufacturing method according to a second embodiment.

### DESCRIPTION OF EMBODIMENTS

Hereinafter, embodiments according to the present invention will be described by way of examples, but the present invention is not limited to the examples described below. In the following description, specific numerical values and materials are given as examples in some cases, but other numerical values and other materials may also be applied as long as the invention according to the present disclosure can be implemented. In the specification, the expression “numerical value A to numerical value B” includes numerical value A and numerical value B, and can be read as “numerical value A or more and numerical value B or less”. In the following description, when lower and upper limits of numerical values related to specific physical properties or conditions are given as examples, any of the lower limits and upper limits given as examples can be combined as appropriate as long as the lower limit is not greater than or equal to the upper limit.

### Manufacturing Method for Electrolytic Capacitor

An example of a manufacturing method according to the present disclosure will be described below. The manufacturing method according to the present disclosure is a manufacturing method for an electrolytic capacitor. Hereinafter, the manufacturing method will also be called “manufacturing method (M)”.

The manufacturing method (M) is a manufacturing method for an electrolytic capacitor including at least one anode foil with a dielectric layer formed on a surface thereof, at least one cathode foil, and at least one separator. The manufacturing method (M) includes a laminated body formation step and a polymer layer formation step in the stated order.

The laminated body formation step is a step of forming the laminated body by laminating the anode foil, the cathode foil, and the separator such that the separator is arranged between the anode foil and the cathode foil. The polymer layer formation step is a step of impregnating the laminated body with the dispersion liquid containing the conductive polymer and the dispersion medium, and then evaporating at least a portion of the dispersion medium of the dispersion liquid in the laminated body to form a conductive polymer layer containing the conductive polymer in the laminated body. Hereinafter, the dispersion liquid will also be called “dispersion liquid (D)”.

The laminated body formation step further includes a step of surrounding the outer periphery of the laminated body with a binding member. The separator has a protrusion part that protrudes from the binding member. In the polymer layer formation step, the laminated body is impregnated with the dispersion liquid (D) from the protrusion part.

In the manufacturing method (M), the laminated body may be impregnated with the dispersion liquid (D) from the protrusion part and a part other than the protrusion part. Alternatively, in the manufacturing method (M), the laminated body may be impregnated with the dispersion liquid (D) from only the protrusion part.

In the manufacturing method (M), the laminated body is impregnated with the dispersion liquid (D) from the protrusion part that protrudes from the binding member that binds the laminated body. Since the protrusion part is not bound, the dispersion liquid (D) quickly penetrates into the protrusion part. On the other hand, the protrusion part is connected to a part of the separator that is bound with the binding member. The part of the laminated body that is bound with the binding member will also be called “bound part”. At the bound part, the interval between the anode foil and the cathode foil is narrower, and the separator is more compressed than the protrusion part. Therefore, when the dispersion liquid (D) that has permeated the protrusion part reaches the bound part, the dispersion liquid (D) is guided into the bound part by capillary action. Accordingly, the dispersion liquid (D) is thought to permeate into the inside of the laminated body more easily. Therefore, the manufacturing method (M) makes it possible to form the conductive polymer layer with more uniformity. The manufacturing method (M) makes it possible to manufacture an electrolytic capacitor with a low equivalent series resistance (ESR). Furthermore, the manufacturing method (M) makes it possible to reduce variations in the characteristics of the manufactured electrolytic capacitors.

The laminated body may include a plurality of protrusion parts. For example, the laminated body may include a plurality of separators, and each of the separators may include a protrusion part. In the polymer layer formation step, the laminated body may be impregnated with the dispersion liquid (D) while the interval between the plurality of protrusion parts is widened. For example, the interval between the plurality of protrusion parts may be widened the farther from the bound part it is. According to this configuration, the dispersion liquid (D) particularly easily penetrates into the protrusion parts. Therefore, it is possible to increase the amount of the dispersion liquid (D) that is to impregnate the laminated body. If the anode foil and the cathode foil also protrude at the position where the protrusion part exists, the laminated body may be impregnated with the dispersion liquid (D) while the interval therebetween is widened.

In a wound-type capacitor element obtained by winding an anode foil, a cathode foil, and a separator, it is difficult to widen the interval between the protrusion parts. On the other hand, in the electrolytic capacitor manufactured with the manufacturing method (M), it is easy to widen the interval between the protrusion parts.

The binding member may have another opening that is different from the opening through which the protrusion part protrudes. The polymer layer formation step may further include a step of injecting the dispersion liquid (D) through the other opening to impregnate the laminated body. This step makes it possible to increase the amount of conductive polymer arranged in the laminated body and to form the conductive polymer layer with more uniformity.

The manufacturing method (M) may further include a step of impregnating the laminated body with a liquid component after the polymer layer formation step. The liquid component may be a liquid component (L) described below.

### Laminated Body Formation Step

The laminated body formation step can be performed by laminating at least one anode foil, at least one cathode foil, and at least one separator in a predetermined order. For example, the anode foil and the cathode foil are alternately arranged, and the separator is arranged between the anode foil and the cathode foil.

The laminated body may have a plate-like shape as a whole. The laminated body may be formed by laminating a flat anode foil, a flat cathode foil, and a flat separator in one direction. The separator is arranged between the anode foil and the cathode foil.

The number of anode foils included in the laminated body may be one or more, two or more, or three or more, and may be 20 or less, 10 or less, or five or less. The number of anode foils ranges from one to 20, from one to 10, or from two to 10. The number of cathode foils included in the laminated body is one or more, and may be the same as or different from the number of anode foils. For example, the number of cathode foils may be one less or one more than the number of anode foils. The number of separators included in the laminated body is one or more. The required number of separators to be arranged between the anode foil and the cathode foil is used.

If a plurality of anode foils are used, the anode foils may be connected in parallel. For example, anode foils having lead tabs are used and the lead tabs are connected to each other. Alternatively, the plurality of anode foils may be connected to each other directly or using a connecting member. If a plurality of cathode foils are used, the cathode foils may be connected in parallel to each other in a similar manner.

The separator is usually larger than the anode foil and the cathode foil. The separator usually extends outside the region where the anode foil and the cathode foil face each other. The anode foil and the cathode foil are generally the same size, and one of them may be slightly larger than the other. There is no limitation on the planar shapes of the anode foil, the cathode foil, and the separator, and they may be rectangular or other than rectangular.

### Polymer Layer Formation Step

In the polymer layer formation step of the manufacturing method (M), the laminated body can be impregnated with the dispersion liquid with the above-mentioned technique. The impregnation with the dispersion liquid may be performed under reduced pressure. At least a portion of the dispersion medium can be evaporated (removed) by heating and/or pressure reduction, and at least heating is preferred. The heating temperature may be any temperature at which the dispersion medium evaporates, and may be 80° C. or higher, 100° C. or higher, or 120° C. or higher, and may be 200° C. or lower, or 180° C. or lower, for example. The heating temperature may range from 100 to 200° C. The heating time may be set as appropriate according to the dispersion medium and the heating temperature. If the dispersion medium contains water, it is preferred that not much dispersion medium ultimately remains in the laminated body. Most of the dispersion medium may be removed, or substantially all of the dispersion medium may be removed.

The step of impregnation with the dispersion liquid and drying (evaporation of the dispersion medium) may be repeated a plurality of times. For example, the step may be performed two to five times. Repeating this step a plurality of times allows more conductive polymers to be arranged in the laminated body.

In the manufacturing method (M), a conductive polymer layer may be formed in advance on at least one selected from the group consisting of an anode foil, a cathode foil, and a separator used to form the laminated body. In this case, a second conductive polymer layer is formed by the polymer layer formation step on a first conductive polymer layer that was formed in advance. The first conductive polymer layer can be formed by applying a dispersion liquid containing a conductive polymer and then drying the applied coating liquid, for example. As the dispersion liquid and drying conditions, the dispersion liquid and drying conditions described above in relation to the polymer layer formation step may be adopted.

In the manufacturing method (M), there are no particular limitations on the steps after the polymer layer formation step, and any steps needed to manufacture the electrolytic capacitor may be performed. There are no limitations on these steps, and any known steps may be implemented. For example, the manufacturing method (M) may include, after the polymer layer formation step, a step of enclosing the laminated body bound with the binding member in an exterior body. Furthermore, the manufacturing method (M) may include a step of impregnating the laminated body with the liquid component (L) described below.

In the manufacturing method (M), when viewed from the laminating direction of the laminated body, the binding member may cover an area of the laminated body ranging from 70 to 100%, 80 to 100%, or 70 to 90% of the region in which at least one of the anode foil and the cathode foil is present. The planar shape of the binding member may be larger or smaller than the planar shape of the laminated body. All of the main surface of the anode foil and the main surface of the cathode foil present on the surface of the laminated body may be covered by the binding member. According to this configuration, the anode foil and the cathode foil can suppress short-circuiting of the laminated body. In the manufacturing method (M), the binding member may be thermally shrunk after the polymer layer formation step. Thermally shrinking the binding member after the polymer layer formation step shortens the distance between the electrodes in the laminated body, and therefore the ESR can be reduced.

In the manufacturing method (M), the binding member may be thermally shrunk after the laminated body formation step. For example, in the polymer layer formation step, the laminated body impregnated with the dispersion liquid may be heated to evaporate at least a portion of the dispersion medium, and the binding member may be thermally shrunk when the laminated body is heated. According to this configuration, it is not necessary to separately perform a step of thermally shrinking the binding member. In this case, the heating temperature for evaporating the dispersion liquid is a temperature greater than or equal to the temperature at which the binding member is thermally shrunk. Thermally shrinking the binding member after the laminated body formation step allows shortening of the distance between the electrodes in the laminated body and formation of the polymer layer to take place simultaneously. By thermally shrinking the binding member after the laminated body formation step, it is possible to reduce the ESR.

The manufacturing method (M) may further include a step of enclosing the laminated body in which the conductive polymer layer is formed in an exterior body, after the polymer layer formation step.

In the manufacturing method (M), the laminated body may be impregnated with the dispersion liquid by placing the laminated body in the exterior body in which the dispersion liquid is disposed.

In the manufacturing method (M), the laminated body may be impregnated with a predetermined amount of dispersion liquid (D). For example, the laminated body may be impregnated with a predetermined amount of dispersion liquid (D) by putting the predetermined amount of dispersion liquid (D) in a container and impregnating the laminated body with the dispersion liquid (D). Alternatively, the laminated body may be impregnated with a predetermined amount of dispersion liquid (D) by supplying the predetermined amount of dispersion liquid (D) to the protrusion part. Further, the laminated body may be impregnated with a predetermined amount of liquid component (L) using a method similar to these methods. By controlling the impregnation amount(s) of dispersion liquid (D) and/or liquid component (L), variations in the characteristics of a large number of manufactured electrolytic capacitors can be reduced.

### Electrolytic Capacitor

The present disclosure provides an electrolytic capacitor. Since the electrolytic capacitor can be manufactured using the manufacturing method (M), redundant description will be omitted. The electrolytic capacitor includes at least one anode foil having a dielectric layer formed on a surface thereof, at least one cathode foil, and at least one separator. The anode foil, the cathode foil, and the separator are laminated such that the anode foil and the cathode foil are arranged alternatingly and the separator is arranged between the anode foil and the cathode foil. The electrolytic capacitor includes a conductive polymer layer formed in the laminated body. The electrolytic capacitor includes the binding member surrounding the outer periphery of the laminated body. The separator has the protrusion part that protrudes from the binding member. The electrolytic capacitor may include the liquid component (L) with which the laminated body is impregnated.

An example of a configuration and components of the electrolytic capacitor manufactured using the manufacturing method (M) will be described below. The configuration and components of the electrolytic capacitor manufactured using the manufacturing method (M) are not limited to the following example. Publicly known components may be used for the components constituting the laminated body.

The electrolytic capacitor includes a laminated body and a binding member. The electrolytic capacitor may include other components. Examples of such other components include an exterior body, a liquid component (L), a lead member, and the like. The laminated body functions as a capacitor element. The laminated body includes an anode foil having a dielectric layer formed on a surface thereof, a cathode foil, and a separator.

### Binding Member

The binding member is made of a resin composition, for example. A tubular member may be used as the binding member. Alternatively, the binding member may be formed by adhering films together. The binding member preferably has insulation properties and is preferably formed of an insulating material. The binding member need only surround at least a portion of the outer periphery of the laminated body. The binding member may surround the entire outer periphery of the laminated body except for the protrusion part of the separator. Alternatively, the binding member may surround a portion of the outer periphery of the laminated body except for the protrusion part of the separator. The binding member may have an envelope-like shape with an opening at one or both ends.

The binding member may be made of a material that shrinks when heated. For example, the binding member may be made of a composition (for example, a resin composition) that contains a heat-shrinkable material (for example, a resin). Examples of the heat-shrinkable material include polyethylene, polyethylene terephthalate, polybutylene terephthalate, polyamide, polyacetal, polypropylene, polyphenylene sulfide, polyvinyl chloride, polyolefin, polyester, heat-shrinkable silicone rubber, heat-shrinkable fluororubber, and the like.

The temperature at which the binding member thermally shrinks may be 80° C. or more, 100° C. or more, 120° C. or more, or 140° C. or more, and may be 200° C. or less, or 180° C. or less.

When adhering films together to form a binding member, each film may include a heat-sealing layer on at least one side. There is no particular limitation on the heat seal layer, and any publicly known heat seal layer can be used. The films constituting the binding member may be laminated films.

### Anode Foil

Examples of the anode foil include metal foils containing at least one valve metal such as titanium, tantalum, aluminum, and niobium, and the anode foil may be a metal foil of a valve metal (for example, an aluminum foil). The anode foil may contain a valve metal in the form of an alloy containing the valve metal, a compound containing the valve metal, or the like. The thickness of the anode foil may be 15 μm or more and 300 μm or less. The surface of the anode foil may be roughened by etching or the like.

A dielectric layer is formed on the surface of the anode foil. The dielectric layer may be formed by subjecting the anode foil to chemical conversion treatment. In this case, the dielectric layer may contain an oxide of a valve metal (for example, an aluminum oxide). The dielectric layer need only function as a dielectric and may be made of any dielectric other than an oxide of a valve metal.

### Cathode Foil

The cathode foil is not particularly limited as long as it functions as a cathode. Examples of the cathode foil include a metal foil (for example, an aluminum foil). The kind of the metal is not particularly limited, and may be a valve metal or an alloy containing a valve metal. The thickness of the cathode foil may be 15 μm or more and 300 μm or less. The surface of the cathode foil may be roughened or subjected to chemical conversion treatment as necessary.

The cathode foil may include a conductive coating layer. If the metal foil used for the cathode foil contains a valve metal, the coating layer may contain carbon and at least one metal having a lower ionization tendency than the valve metal. This makes it easier to improve the acid resistance of the metal foil. If the metal foil contains aluminum, the coating layer may contain at least one selected from the group consisting of carbon, nickel, titanium, tantalum, and zirconium. In particular, the coating layer may include nickel and/or titanium in terms of low cost and resistance.

The thickness of the coating layer may be 5 nm or more, or 10 nm or more, and may be 200 nm or less. The coating layer may be formed by evaporation or sputtering of the above metal onto the metal foil. Alternatively, the coating layer may be formed by evaporation of a conductive carbon material onto the metal foil or by application of a carbon paste containing a conductive carbon material to the metal foil. Examples of the conductive carbon material include graphite, hard carbon, soft carbon, carbon black, and the like.

### Separator

A porous sheet can be used as the separator. Examples of the separator include woven fabrics, nonwoven fabrics, and microporous membranes. The thickness of the separator is not particularly limited and may be in the range of 10 to 300 μm. Examples of a material for the separator include cellulose, polyethylene terephthalate, polybutylene terephthalate, polyphenylene sulfide, vinylon, nylon, aromatic polyamide, polyimide, polyamide imide, polyetherimide, rayon, glass, and the like.

### Conductive Polymer Layer

The conductive polymer layer contains a conductive polymer, and may contain a conductive polymer and a dopant.

Examples of the conductive polymer include polypyrrole, polythiophene, polyfuran, polyaniline, polyacetylene, and derivatives thereof. The derivatives include polymers having polypyrrole, polythiophene, polyfuran, polyaniline, and polyacetylene as the basic skeleton. For example, derivatives of polythiophene include poly(3,4-ethylenedioxythiophene), and the like. These conductive polymers may be used alone or in combination. The conductive polymer may also be a copolymer of two or more monomers. The weight-average molecular weight of the conductive polymer is not particularly limited and may be in the range of 1,000 to 100,000, for example. A preferred example of the conductive polymer is poly(3,4-ethylenedioxythiophene) (PEDOT).

The conductive polymer may be doped with a dopant. From the viewpoint of suppressing de-doping from the conductive polymer, it is preferable to use a polymer dopant as the dopant. Examples of the polymeric dopant include polyvinyl sulfonic acid, polystyrene sulfonic acid, polyallyl sulfonic acid, polyacryl sulfonic acid, polymethacryl sulfonic acid, poly(2-acrylamido-2-methylpropanesulfonic acid), polyisoprene sulfonic acid, polyacrylic acid, and the like. These may be used alone or in combination of two or more. At least some of these may be added in the form of a salt. A preferred example of the dopant is polystyrene sulfonic acid (PSS).

In the electrolytic capacitor of the present disclosure, the dopant may be a dopant containing an acidic group, or may be a polymer dopant containing an acidic group. Examples of the acidic group include a sulfonic acid group, a carboxyl group, and the like. The polymer dopant containing an acidic group is a polymer in which at least some of the constituent units contain an acidic group. Examples of such a polymer dopant include the polymer dopants described above.

The weight-average molecular weight of the dopant is not particularly limited. From the viewpoint of facilitating the formation of a homogeneous conductive polymer layer, the weight-average molecular weight of the dopant may be set in the range of 1,000 to 100,000.

The dopant may be polystyrene sulfonic acid and the conductive polymer may be poly(3,4-ethylenedioxythiophene). That is, the conductive polymer component may be poly(3,4-ethylenedioxythiophene) doped with polystyrene sulfonic acid.

### Dispersion Liquid (D)

The dispersion liquid (D) contains a conductive polymer, and a dopant as necessary. The conductive polymer and the dopant may be dispersed in the dispersion liquid (D) in the form of particles. The dispersion medium in the dispersion liquid (D) may contain water or may be water.

The proportion of the conductive polymer in the dispersion liquid (D) may be 0.5% by mass or more, or 1.0% by mass or more, and may be 5.0% by mass or less, 3.0% by mass or less, or 2.0% by mass or less. The proportion may be in the range of 0.5 to 5.0% by mass (for example, in the range of 1.0 to 3.0% by mass).

### Liquid Component (L)

Examples of the liquid component (L) used in the impregnation step include a non-aqueous solvent and an electrolytic solution. The electrolytic solution may be an electrolytic solution containing a non-aqueous solvent and a solute dissolved therein. In the specification, the liquid component (L) may be a component that is liquid at room temperature (25° C.) or a component that is liquid at the temperature during use of the electrolytic capacitor.

The liquid component (L) may be a non-aqueous solvent or an electrolyte solution containing a non-aqueous solvent and a solute dissolved therein. The non-aqueous solvent may be an organic solvent or an ionic liquid. The solute may be an organic salt.

As the non-aqueous solvent, a high-boiling solvent is preferred. Examples of the non-aqueous solvent include polyhydric alcohols such as ethylene glycol and propylene glycol, cyclic sulfones such as sulfolane, lactones such as y-butyrolactone, amides such as N-methylacetamide, N,N-dimethylformamide, and N-methyl-2-pyrrolidone, esters such as methyl acetate, carbonate compounds such as propylene carbonate, ethers such as 1,4-dioxane, ketones such as methyl ethyl ketone, formaldehyde, and the like.

The organic salt is a salt in which at least one of an anion and a cation contains an organic substance. Examples of the organic salt include trimethylamine maleate, triethylamine borodisalicylate, ethyldimethylamine phthalate, mono-1,2,3,4-tetramethylimidazolinium phthalate, and mono-1,3-dimethyl-2-ethylimidazolinium phthalate, and the like.

### Exterior Body

The exterior body may be made of at least one selected from the group consisting of a case, a laminate film, and a sealing resin. There is no limitation to these, and the exterior body may be made of a known case and a sealing resin. The sealing resin may include a thermosetting resin. Examples of the thermosetting resin include an epoxy resin, a phenolic resin, a silicone resin, a melamine resin, a urea resin, an alkyd resin, polyurethane, polyimide, unsaturated polyester, and the like. The sealing resin may contain a filler, a curing agent, a polymerization initiator, and/or a catalyst, and the like.

Hereinafter, examples of the present disclosure will be specifically described with reference to the drawings. The examples described below can be modified based on the above description. The matters described below may also be applied to the above embodiment. In the examples described below, steps and components that are not essential to the manufacturing method according to the present disclosure can be omitted.

### First Embodiment

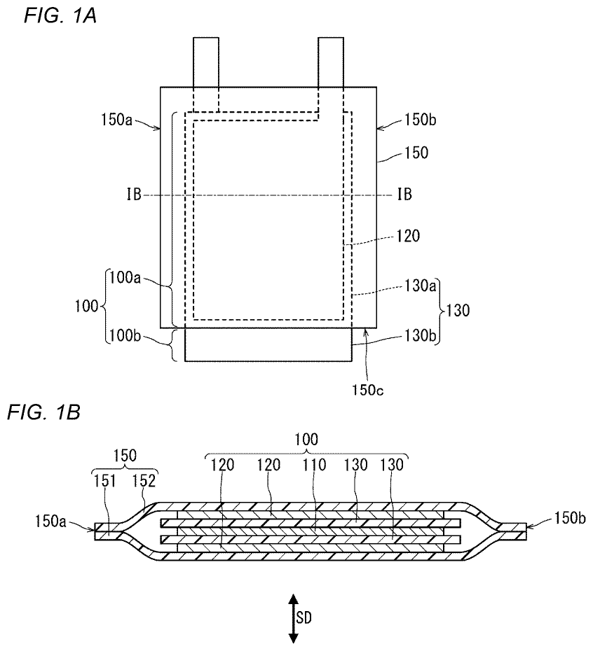

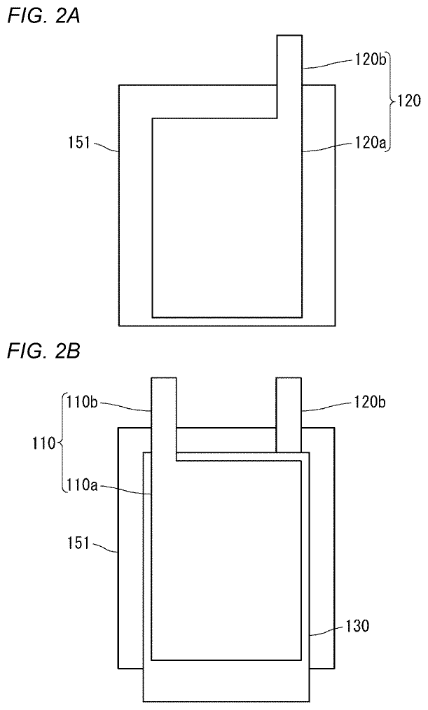

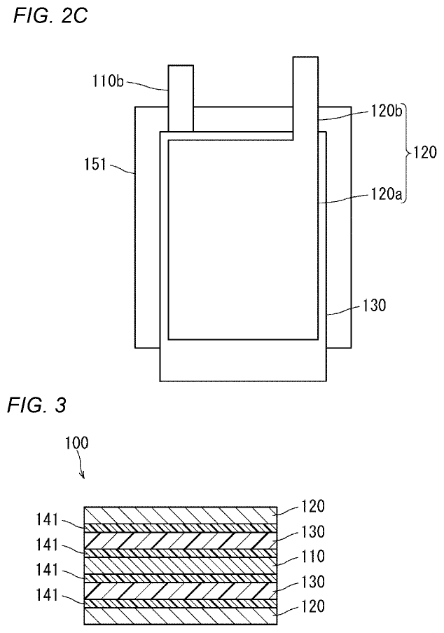

In a first embodiment, an example of the manufacturing method (M) will be described. In the manufacturing method, first, as shown in FIGS. 1A and 1B, a laminated body 100 bound with a binding member 150 is formed. FIG. 1A is a top view of the laminated body 100 and the binding member 150. FIG. 1B is a cross-sectional view taken along line IB-IB in FIG. 1A. FIGS. 2A to 2C show planar shapes of members constituting the laminated body 100.

The laminated body 100 includes an anode foil 110, cathode foils 120, and separators 130. A dielectric layer (not shown) is formed on the surface of the anode foil 110. The laminated body 100 is formed by laminating the anode foil 110, the cathode foils 120, and the separators 130 such that the separators 130 are arranged between the anode foil 110 and the cathode foils 120. The laminated body 100 is formed by laminating the anode foil 110 that is substantially flat, the cathode foils 120 that are substantially flat, and the separators 130 that are substantially flat, along a laminating direction SD.

The anode foil 110 includes a rectangular element part 110a and a lead part 110b. The cathode foil 120 includes a rectangular element part 120a and a lead part 120b. The laminated body 100 includes a bound part 100a that is bound with the binding member 150 and a protrusion part 100b that protrudes from the binding member 150. The separator 130 includes a bound part 130a that is bound with the binding member 150 and a protrusion part 130b that protrudes from the binding member 150. In the example shown in FIGS. 1A and 1B, the protrusion part 100b is constituted of only the protrusion part 130b.

When viewed from the laminating direction SD of the laminated body 100, the binding member 150 covers the entire region where the anode foil 110 and the cathode foils 120 are present. According to this configuration, the anode foil and the cathode foils can suppress short-circuiting of the laminated body.

The binding member 150 is formed by heat-sealing a first laminate film 151 and a second laminate film 152 at two sides 150a and 150b. One side of the binding member 150, which is the side opposite to the protrusion part 130b, may be heat-sealed or may not be heat-sealed. The binding member 150 has at least an opening 150c (first opening 150c).

An example of a method for fabricating the laminated body 100 shown in FIG. 1A will be described below. First, as shown in FIG. 2A, the cathode foil 120 is arranged on the first laminate film 151. Next, the separator 130 is arranged so as to cover the cathode foil 120, and the anode foil 110 is arranged on the separator 130 (FIG. 2B). Then, the separator 130 is arranged so as to cover the anode foil 110, and the cathode foil 120 is arranged on the separator 130 (FIG. 2C). Next, the second laminate film 152 is arranged so as to overlap with the first laminate film 151, and at least two sides thereof are heat-sealed. Accordingly, an envelope-shaped binding member 150 having at least one opening is obtained. In this manner, the laminated body 100 bound with the binding member 150 shown in FIGS. 1A and 1B is formed. The lead parts 120b of the two cathode foils 120 are connected to each other at any stage after the step of FIG. 2C. They may be connected by welding or the like.

Next, a conductive polymer layer is formed using the following procedure. First, a dispersion liquid (D) containing a conductive polymer is prepared. Then, the laminated body 100 is impregnated with the dispersion liquid (D) from the protrusion part 130b (impregnation step (a)). For example, the dispersion liquid (D) may be arranged in a container, and the protrusion part 130b may be immersed in the dispersion liquid (D). Alternatively, the dispersion liquid (D) may be applied or dripped onto the protrusion part 130b. Further, in the impregnation step, the laminated body 100 may be impregnated with the dispersion liquid (D) while the interval between the protrusion parts 130b is widened, as described above.

Next, the dispersion liquid (D) with which the laminated body 100 is impregnated is heated at a predetermined heating temperature to remove at least a portion of the dispersion medium in the dispersion liquid (D) (drying step (b)). In this manner, a conductive polymer layer can be formed between the dielectric layer on the surface of the anode foil 110 and the cathode foil 120. The conductive polymer layer can be formed on the dielectric layer on the surface of the anode foil 110, on the cathode foil 120, and inside and on the surface of the separator 130. As described above, the formation step including the impregnation step (a) and the drying step (b) may be repeated a plurality of times.

FIG. 3 is a schematic enlarged view of a portion of the laminated body 100 in which conductive polymer layers are formed. Referring to FIG. 3, conductive polymer layers 141 are formed on the dielectric layers (not shown) on the surface of the anode foil 110 and on the cathode foils 120. The conductive polymer layers 141 are also formed in voids inside the separators 130 and on the surfaces of the separators 130. The conductive polymer layers 141 on the electrode foils are formed on the surfaces of the anode foil 110 and the cathode foils 120 that face each other.

Using the binding member 150 that thermally shrinks at the heating temperature in the drying process causes the binding member 150 (the laminate films 151 and 152) to be thermally shrunk in the drying process. In this manner, a conductive polymer layer can be formed. As described above, the process including the impregnation process and the drying process may be repeated a plurality of times.

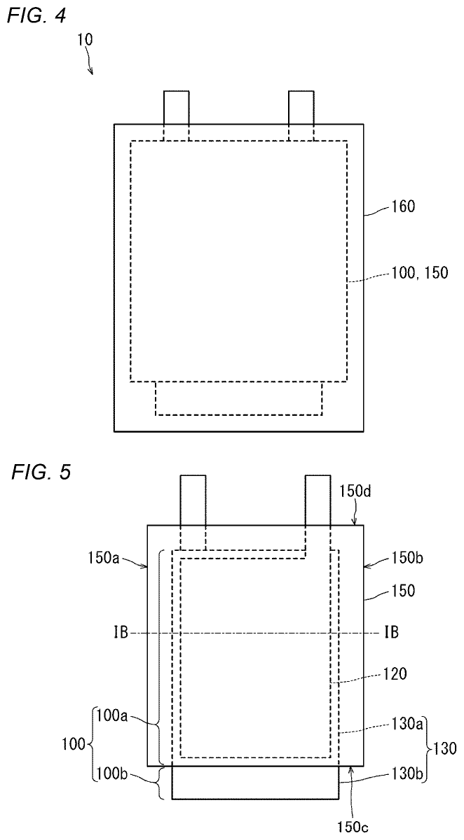

Next, the laminated body 100 bound with the binding member 150 is enclosed in the exterior body. For example, the laminated body 100 and the binding member 150 are enclosed in the exterior body 160 as shown in FIG. 4. There are no limitations on the exterior body and the method for enclosing in the exterior body, and any known exterior body and method may be used. In this manner, the electrolytic capacitor 10 is manufactured.

### Second Embodiment

In a second embodiment, another example of the manufacturing method (M) will be described. In the manufacturing method, first, as in the first embodiment, a laminated body 100 bound with a binding member 150 shown in FIGS. 1A and 1B is formed. The laminated body 100 and the binding member 150 can be formed using the above-described method in the first embodiment. However, the binding member 150 according to the second embodiment is heat-sealed along two sides 150a and 150b, and is not heat-sealed at one side opposite to a protrusion part 130b. Therefore, the binding member 150 has a first opening 150c and a second opening 150d. The protrusion part 130b protrudes from the first opening 150c. A separator 130 does not protrude from the second opening 150d.

Next, a polymer layer formation step of forming a conductive polymer layer is performed. The polymer layer forming step according to the second embodiment includes an impregnation step (a1), a drying step (b1), an impregnation step (a2), and a drying step (b2). The impregnation step (a1) is a step of impregnating the laminated body 100 with a dispersion liquid (D) from the protrusion part 130b. The drying step (b1) is a step of evaporating at least a portion of the dispersion medium in the dispersion liquid (D) with which the laminated body 100 was impregnated in the impregnation step (a1). The impregnation step (a2) is a step of injecting the dispersion liquid (D) through the second opening 150d (another opening) to impregnate the laminated body 100. The drying step (b2) is a step of evaporating at least a portion of the dispersion medium in the dispersion liquid (D) with which the laminated body 100 was impregnated in the impregnation step (a2). The impregnation step (a1), the drying step (drying step (b1), and the drying step (b2)) can be performed using the method described above.

In the impregnation step (a2), it is preferable to inject the dispersion liquid (D) through the second opening 150d so that the dispersion liquid (D) reaches the protrusion part 130b. The impregnation step (a2) may be performed in a state in which the second opening 150d is arranged above the first opening 150c. Since the separator 130 is larger than an element part 110a of an anode foil 110 and an element part 120a of a cathode foil 120, the separator 130 protrudes beyond the element parts 110a and 120a on the second opening 150d side. The injected dispersion liquid (D) can permeate the laminated body 100 through the separator 130 protruding from the element parts 110a and 120a.

In one example, a first polymer layer formation step including the impregnation step (a1) and the drying step (b1) is performed, followed by a second polymer layer formation step including the impregnation step (a2) and the drying step (b2). The first polymer layer formation step may be performed a plurality of times, or the second polymer layer formation step may be performed a plurality of times.

The order of the first polymer layer formation step and the second polymer layer formation step is not limited, and either one may be performed first. For example, the second polymer layer formation step may be performed before the first polymer layer formation step. If at least one of the first polymer layer formation step and the second polymer layer formation step is performed a plurality of times, the order of the steps can be set as desired.

The impregnation step (a1) and the impregnation step (a2) may be performed at the same time. That is, in the impregnation step, the laminated body 100 may be impregnated with the dispersion liquid (D) from the protrusion part 130b and the opening 150d at the same time. In this case, in the drying step, at least a portion of the dispersion medium is removed from the dispersion liquid (D) with which the laminated body 100 is impregnated through the protrusion part 130b and the opening 150d.

Next, the laminated body 100 is impregnated with a liquid component (L). In this manner, the laminated body 100 containing the conductive polymer layer and the liquid component (L) is obtained. The obtained laminated body 100 is enclosed in an exterior body to obtain an electrolytic capacitor. The laminated body 100 can be impregnated with the liquid component (L) through the protrusion part 130b and/or the second opening 150d.

The laminated body 100 may be impregnated with the liquid component (L) while placed in the exterior body having an opening. In that case, the opening of the exterior body may be sealed after the laminated body is impregnated with the liquid component (L).

### Industrial Applicability

The present disclosure can be applied to an electrolytic capacitor. Although the present invention has been described with respect to the present preferred embodiments, such disclosure should not be interpreted as being limited. Various modifications and alterations will undoubtedly become apparent to those skilled in the art to which the present invention pertains upon reading the above disclosure. Therefore, the appended claims should be interpreted to include all modifications and alterations without departing from the true spirit and scope of the present invention.

### Reference Signs List

10: electrolytic capacitor, 100: laminated body, 100a: bound part, 100b: protrusion part, 110: anode foil, 120: cathode foil, 130: separator, 130b: protrusion part, 141: conductive polymer layer, 150: binding member, 150c: opening, 150c: first opening, 150d: second opening, SD: laminating direction

1. A manufacturing method for an electrolytic capacitor that includes at least one anode foil having a dielectric layer formed on a surface thereof, at least one cathode foil, and at least one separator, the manufacturing method comprising:
a laminated body formation step of forming a laminated body by laminating the anode foil, the cathode foil, and the separator such that the separator is arranged between the anode foil and the cathode foil; and
a polymer layer formation step of impregnating the laminated body with a dispersion liquid containing a conductive polymer and a dispersion medium, and then evaporating at least a portion of the dispersion medium of the dispersion liquid in the laminated body to form a conductive polymer layer containing the conductive polymer in the laminated body,
wherein the laminated body formation step further includes a step of surrounding an outer periphery of the laminated body with a binding member,
the separator has a protrusion part that protrudes from the binding member, and
in the polymer layer formation step, the laminated body is impregnated with the dispersion liquid from the protrusion part.

2. The manufacturing method according to claim 1,
wherein the laminated body includes a plurality of the protrusion parts, and
in the polymer layer formation step, the laminated body is impregnated with the dispersion liquid while an interval between the plurality of protrusion parts is widened.

3. The manufacturing method according to claim 1,
wherein the binding member has another opening that is different from an opening through which the protrusion part protrudes, and
the polymer layer formation step includes a step of injecting the dispersion liquid through the other opening to impregnate the laminated body.

4. The manufacturing method according to claim 1, further comprising a step of impregnating the laminated body with a liquid component after the polymer layer formation step.

5. The manufacturing method according to claim 1, wherein when viewed from a laminating direction of the laminated body, the binding member covers an area ranging from 70 to 100% of a region where at least one of the anode foil and the cathode foil is present.

6. The manufacturing method according to claim 1, wherein the binding member is thermally shrunk after the polymer layer formation step.

7. The manufacturing method according to claim 1, wherein the binding member is thermally shrunk after the laminated body formation step.

8. The manufacturing method according to claim 7,
wherein in the polymer layer formation step, the laminated body impregnated with the dispersion liquid is heated to evaporate at least a portion of the dispersion medium, and
the binding member is thermally shrunk when the laminated body is heated.

9. The manufacturing method according to claim 1, further comprising a step of enclosing the laminated body in which the conductive polymer layer is formed in an exterior body, after the polymer layer formation step.

10. The manufacturing method according to claim 9, wherein the impregnation of the laminated body with the dispersion liquid is performed by arranging the laminated body in the exterior body in which the dispersion liquid is arranged.
